(19) United States
(12) Patent Application Publication
(10) Pub. No.: US 2003/0038804 A1
(43) Pub. Date: Feb. 27, 2003

(54) Fast drawing method and apparatus for large picture data

(75) Inventor: Hideaki Hontao, Tokyo (JP)

Correspondence Address: Mason & Associates, P.A., 17757 U.S. Hwy 19 North, Suite 500, Clearwater, FL, 33764, US

(73) Assignee: TOOL KABUSHIKI KAISHA

(21) Appl. No.: 10/213,848

(22) Filed: Aug. 7, 2002

(30) Foreign Application Priority Data
Aug. 23, 2001 (JP) 2001-252578

(51) Int. Cl. G06T 11/20

(52) U.S. Cl. 345/441

(57) ABSTRACT

Disclosed are a fast, large scale picture data drawing method and apparatus. According to the present invention, this method comprises the steps of:

regarding original picture data which is to be drawn as picture map data for each of multiple small areas having a predetermined size;

determining, while taking into account the resolution of the display device used for displaying the picture data for each small area, whether the drawing of an original picture should be performed or whether the drawing of a default picture (dot filling), at least part of which is omitted, should be performed; and

displaying the picture data for each small area, in accordance with the results of the determination, so that the required processing time can be reduced.

### BACKGROUND OF THE INVENTION

1. Field of the Invention

The present invention relates to a method and apparatus for fast drawing the data for a large picture, for logically processing an enormous amount of picture data, such as design data for a large integrated circuit or another circuit or various other CAD data, which is represented using XY coordinates, and for quickly drawing the resultant picture data on a display device.

2. Related Arts

The amount of circuit design data required for a large integrated circuit, for example, is enormous, and an extended processing time is required to present such data on a display device. One method currently employed for this purpose provides for the alternate display of a complete picture and a desired portion of that picture. In this case, the entire process for displaying the large picture data must be performed repetitively.

According to this display method, generally, secondary storage means for storing picture data and primary storage means for storing data as a vertex string expression are employed. Data in the vertex string expression are read from the secondary storage means by a drawing request program and are stored unchanged in the primary storage means, while the data stored in the primary storage means is transmitted to a drawing program to be displayed on a display device.

A vertex string expression, an expression consisting of a group of polygons, is prepared by regarding each set of drawing data as a polygon.

According to this drawing method, so long as drawing data are present in the secondary storage means, the drawing request program stores the data in the vertex string expression in the primary storage means, and transmits the data to the drawing program. When the data are received by the drawing program they are converted to obtain bit map data which are then output to the display device.

However, with such a drawing system, one which repetitively issues the same drawing requests, each time a drawing request is issued, the transmission process and the bit mapping process must be performed sequentially for all data, including that data which exceeds the resolution of the display device. Therefore, the processing time required for the system is extended considerably.

Relative to this conventional method, an improved technique therefor has been proposed whereby the secondary storage means is employed for storing drawing data and as the primary storage means for receiving the data from the secondary storage means, and whereby, for the drawing process, the received data is stored both in a vertex string expression and in a bit map expression (Japanese Unexamined Patent Publication No. Hei 5-119764). Compared with the previously described conventional method, the processing time required by this method is reduced considerably.

With this method, however, an extended period of time is also required for the first bit mapping process. Furthermore, even when the process for each dot unit is performed accurately, an unnecessary process must also be performed for picture data which can not be presented because the resolution of the display device will not permit it. In addition, since a reduced size must be used for the display of the picture data for a large area, and since for this purpose dots must be omitted at a predetermined ratio, the data can not be accurately displayed, even though the process is performed for an extended period of time. As a result, certain of the processing which is performed is wasted.

### SUMMARY OF THE INVENTION

To resolve the shortcomings, it is one objective of the present invention to provide a fast, large scale picture data drawing method for quickly and logically displaying, on a display device, a large picture for which the data are represented using XY coordinates, and a fast, large scale picture data drawing apparatus which is appropriate for the execution of this method.

To achieve this objective, the technical means for a first aspect of the invention is a fast, large scale picture data drawing method comprising the steps of:

regarding original picture data which is to be drawn as picture map data for each of multiple small areas having a predetermined size;

determining, while taking into account the resolution of the display device used for displaying the picture data for each small area, whether the drawing of an original picture should be performed or whether the drawing of a default picture, at least part of which is omitted, should be performed; and

displaying the picture data for each small area, in accordance with the results of the determination, so that the required processing time can be reduced.

In this case, according to a second aspect of the invention, the size of the small areas can be selected in accordance with a display enlargement rate. Further, according to a third aspect of the invention, the drawing of the default picture is a process performed by filling the small areas.

Furthermore, the technical means for a fourth aspect of the invention is a fast, large scale picture data drawing apparatus comprising:

picture position analysis means 12 for employing data for an original picture to be drawn to prepare picture map data for each small area which is limited to a predetermined size;

drawing method determination means 14 for employing the picture map data prepared by the picture position analysis means to determine whether an original picture or whether a default picture, at least part of which is omitted, should be displayed for the small area;

picture drawing signal generation means 16 for presenting a corresponding display in accordance with the results of the determination obtained by the drawing method determination means; and

display means 18 for displaying the resultant picture data in accordance with the output of the picture drawing signal generation means.

In this case, according to a fifth aspect, the picture position analysis means 12 performs an analysis for each small area in accordance with the resolution of the display means 18 and the display enlargement rate. In addition, according to a sixth aspect of the invention, the drawing method determination means 14, in consonance with the resolution of the display means, determines whether the original picture or whether, at the least, the default picture, obtained by the filling process, should be displayed.

Each of the small areas represents a segment obtained by dividing the entire area wherein the picture data are present into a set of segments, such as 1000×1000 segments, having a predetermined size. When picture data for all the small areas have been collected, the original picture data can be drawn.

The data in one of these small areas differs from the bit map image data and can be treated as logical data, and for each small area, the processing method can be controlled.

Assuming that 1000×1000 small areas are to be displayed on a display device having 1000×1000 dots, here, one small area will correspond to one dot on the display.

Therefore, for the drawing performed in this case, if even a small amount of picture data is present in a small area, one dot is filled and displayed. Further, if picture data are available for adjacent small areas, these picture data are sequentially merged, and filling, as for a rectangular area, for example, is performed so that the processing time can be reduced.

When a large original picture is divided into 10000×10000 small areas and these areas are displayed on a display device having 1000×1000 dots, the method employed for this invention can be applied even if the length is enlarged 10 times, and the dimensions overall are enlarged 100 times. Further, when one small area corresponds to 5×5 dots, for example, instead of one dot, this method can also be applied even if the length is enlarged 50 times, and the dimensions overall are enlarged 2500 times.

In this case, the number of pictures belonging to each small area can be selected, i.e., whether a default drawing for filling the small area, while using the density of the picture as a reference, should be performed or whether an original picture drawing for drawing individual, included picture data sets should be performed can be selected. As a result, the resolution of the drawing can be controlled in accordance with the enlargement rate or the density of a picture, so that for the picture, drawing performed at a high enlargement rate can be flexibly coped with.

According to the fast, large scale picture data drawing method of the invention, to display large scale picture data for a large integrated circuit, for example, while taking the resolution of a display device into account, the data processing for a range within which drawing is disabled is omitted and a default picture therefor is drawn, while the original picture is drawn for visible picture data.

Thus, the processing time can be considerably reduced for picture data which includes many pictures, or for picture data which should be reduced in size before being displayed.

### BRIEF DESCRIPTION OF THE DRAWINGS

FIG. 1 is a block diagram showing the basic configuration of a fast, large scale picture data drawing apparatus according to the present invention;

FIG. 2 is a flowchart for example processing performed by picture position analysis means in the fast, large scale picture data drawing apparatus according to the present invention;

FIG. 3 is a flowchart showing example processing performed by picture drawing signal generation means in the fast, large scale picture data drawing apparatus according to the invention when a low display enlargement rate has been set;

FIG. 4 is a flowchart showing example processing performed by the picture drawing signal generation means in the fast, large scale picture data drawing apparatus according to the invention when a high display enlargement rate has been set;

FIG. 5 is a flowchart showing example processing performed by the picture drawing signal generation means in the fast, large scale picture data drawing apparatus according to the invention when a mid-level display enlargement rate has been set; and

FIG. 6 is a diagram for explaining the overall processing while the processing and the example resultant displays obtained by the fast, large scale picture data drawing method of the invention are shown.

### DETAILED DESCRIPTION OF THE PREFERRED EMBODIMENT

While referring to the accompanying drawings, a detailed explanation will now be given for a fast, large scale picture data drawing method and a fast, large scale picture data drawing apparatus according to the present invention.

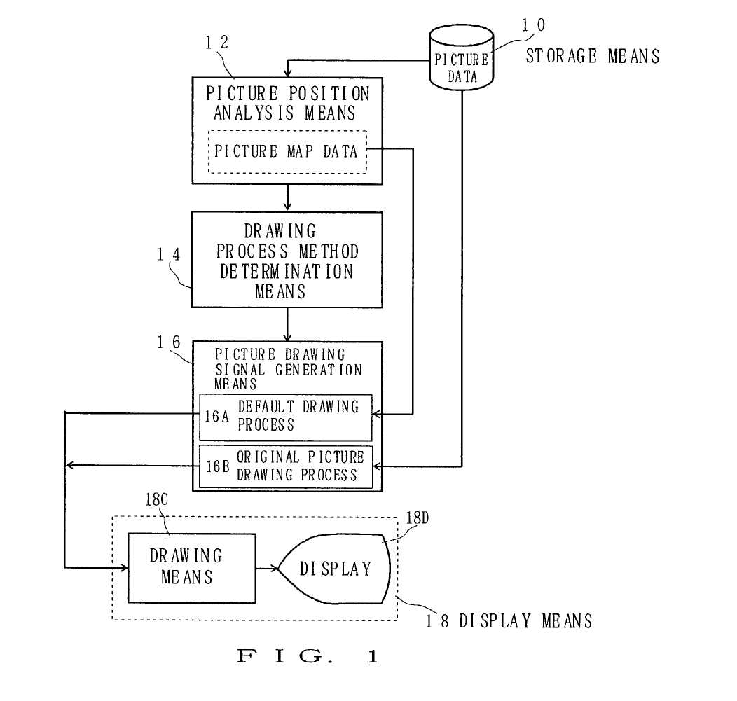

FIG. 1 is a block diagram showing the basic configuration of a fast, large scale picture data drawing apparatus according to the present invention.

An enormous amount of picture data, such as circuit design data and various other CAD data which are to be drawn, which are represented using XY coordinates is stored in storage means 10. Since well known hardware and software can be employed for a computer main body, a picture data preparation program and storage means for preparing and storing these data, no further detailed explanation for them will be given herein.

Picture position analysis means 12 extracts each predetermined unit of picture data which is represented using XY coordinates and which is stored in the picture data storage means 10 by a central processing unit (not shown) and a corresponding processing program, and analyzes the position of the picture data in a picture. This analysis process requires only magnification calculations which do not accompany a drawing command, and the processing time is considerably shorter than the time required for the calculations performed during the conventional drawing process.

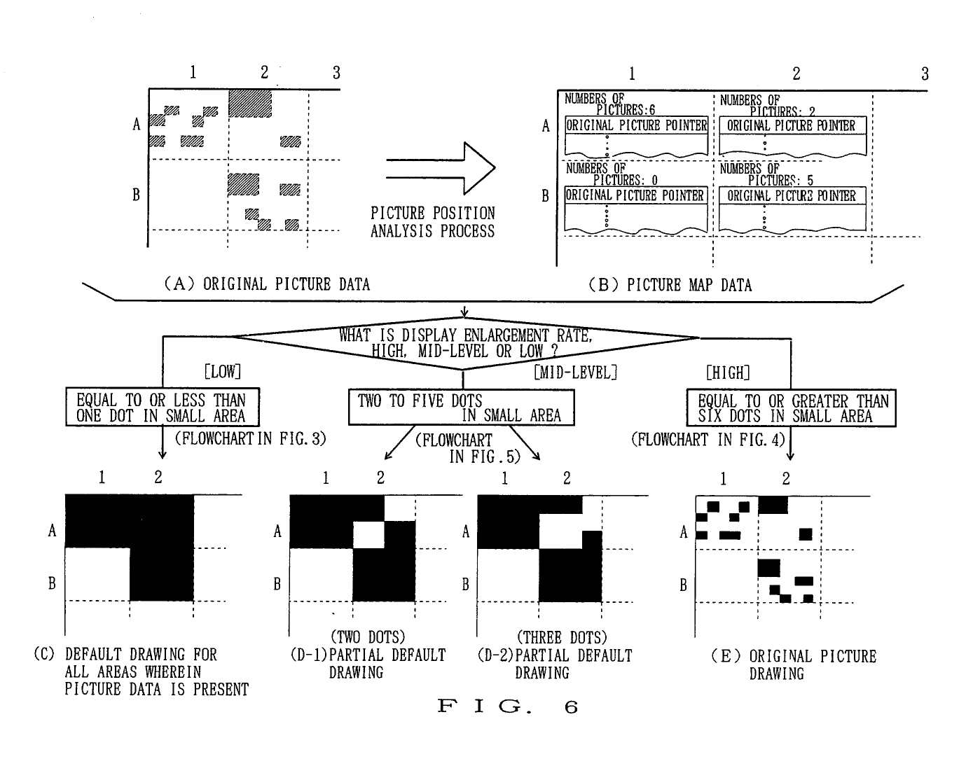

Through an analysis performed by the picture position analysis means 12, a picture display area for each picture is calculated for all the picture data, and picture map data, indicated by a broken line in FIG. 6, are prepared. These picture map data consist of data for each of the small areas obtained by dividing the entire picture data into segments of a predetermined size, and includes, for example, the presence/absence of picture data, the pointer thereof and the number of pictures (density).

Drawing method determination means 14 sequentially extracts the picture map data, and correlates the picture data for a pertinent small area with the original data to determine whether the original picture or the default picture, at least part of which is omitted, should be drawn.

The determination reference is obtained while taking into account the resolution of a display unit or an instruction for the enlargement or reduction of the picture on the display screen. The default drawing in this case includes the drawing process during which a filling process is performed in accordance with the picture data present in a small area.

Picture drawing signal generation means 16 generates a default drawing signal (16A), e.g., a drawing signal for the filling of all or a part of the picture data, for a small area for which the drawing method determination means 14 has determined that the default drawing is appropriate. Further, for a small area for which it is determined that the original picture drawing is appropriate, the picture drawing signal generation means 16 generates an original picture drawing signal (16B) for the picture data which are obtained from the storage means 10.

The default drawing signal and the original picture drawing signal, which have been generated by the picture drawing signal generation means 16, are for drawing the portion in a pertinent small area. One of these thus obtained drawing signals is transmitted to drawing means 18C of display means 18, and is displayed on a display screen 18D.

If the signal for the pertinent small area indicates that the default drawing has been designated, the picture data on the display screen 18D is filled, and if the signal indicates the original picture drawing has been designated, a corresponding picture is displayed. Even when the portion designated for the default drawing is filled, the number of pictures to be drawn for the small area on the display screen 18D and the picture data thereof may exceed the resolution limit of the display, and it may be difficult to view these picture data. However, practically, this adverse affect does not occur.

Since it was determined in advance that the default drawing should be used, the number of processes is reduced and, accordingly, the total processing time is also reduced.. These effects are increased as the number of pictures increases and the density of the pictures displayed in the small area increases because of the display enlargement rate.

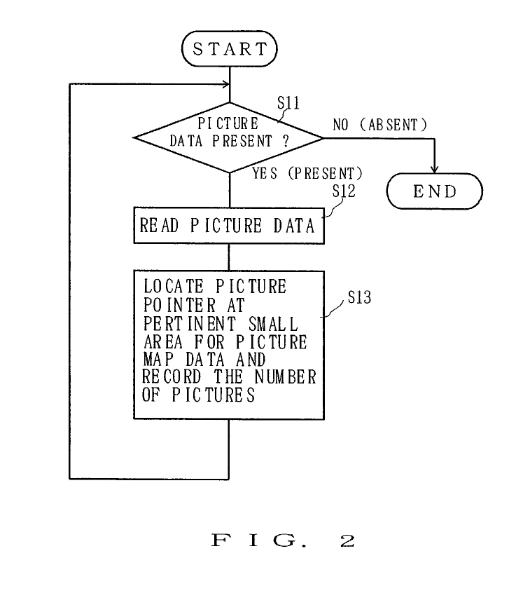

FIG. 2 is a flowchart showing the processing performed by the picture position analysis means 12 in FIG. 1. As the processing is begun, a check is performed to determine whether picture data is present (step S11). When there is picture data to be processed, the picture data is read (step S12).

Then, the entire area wherein picture data which has been read is present is divided into 1000×1000 small areas, and an original picture pointer and the number of pictures are additionally recorded for each corresponding small area to prepare the picture map data (step S13). When, however, it is ascertained at step S11 that no picture data to be processed is present, the processing is terminated.

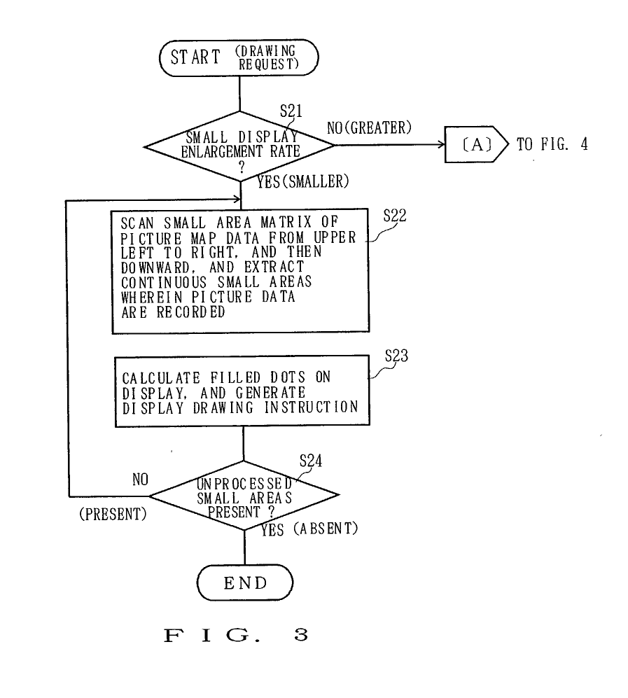

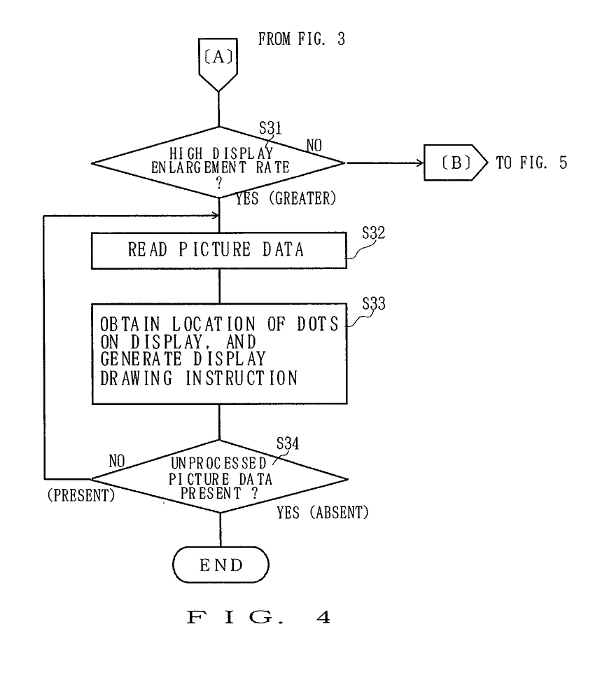

FIG. 3 is a flowchart showing the processing performed by the drawing method determination means 14 and the picture drawing signal generation means 16. Once a drawing request has been issued, the processing is begun. After this, a check is performed to determine whether the display enlargement rate is low, e.g., whether a small area is equal to or smaller than one dot (step S21). When this decision is NO, i.e., when the display enlargement rate is greater than a predetermined value, program control is shifted to process [A], which will be described in detail later while referring to FIG. 4.

When, however, the decision at step S21 is YES (the display enlargement rate is small), beginning at the upper left, the small areas of picture map data are scanned from left to right, from top to bottom, to extract contiguous small areas wherein picture data are recorded (step S22). Then, the dots used for the default drawing on the display are calculated, and a display drawing instruction is generated (step S23).

Thereafter, a check is performed to determine whether a small area which has not been processed is present (step S24). When the decision is NO (an unprocessed small area is present), the process beginning at step S22 is repeated. When the decision is YES (no unprocessed small area is present), the processing is terminated.

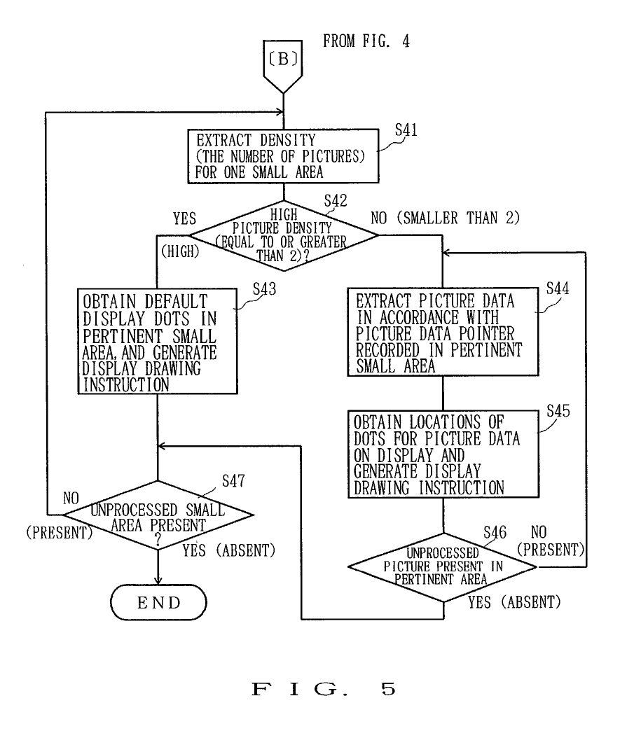

FIG. 4 is a flowchart showing the process [A] performed when the decision at step S21 in FIG. 3 is NO. A check is performed to determine whether the display enlargement rate for the small areas is greater than a predetermined value, five dots, for example (i.e., equal to or greater than six dots) (step S31). When the decision is YES (it is greater than the predetermined value), the picture data is read (step S32). When the decision is NO (it is smaller than the predetermined value), this indicates that the display enlargement rate is mid-level, e.g., 2 to 5 dots, and program control is shifted to process [B], which will be described in detail later while referring to FIG. 5.

The locations of the dots for the picture data on the display are calculated, and a display drawing instruction is generated (step S33). Then, whether unprocessed picture data are present is determined (step S34). When unprocessed picture data are present, the processing beginning at step S32 is repeated. When no unprocessed picture data are present, the processing is terminated.

FIG. 5 is a flowchart showing the process [B] performed when at step S31 in FIG. 4 the display enlargement rate is mid-level, e.g., 2 to 5 dots. As the processing is begun, the density of the picture data in one small area, i.e., the number of pictures, is obtained (step S41). Then, a check is performed to determine whether the density of the obtained picture is high, e.g., equal to or greater than two (step S42).

When the decision is YES, i.e., when the density of the picture data is high, e.g., equal to or greater than two, the number of dots on the display required for a default drawing for the pertinent small area, i.e., required for the filling process, is calculated, and a display drawing instruction is generated (step S43).

When the decision at step S42 is NO, i.e., when the density of the picture data is low, e.g., less than two, the picture data is extracted in accordance with the picture data pointer recorded for the small area for the drawing of an original picture (step S44).

Thereafter, the positions of the dots for the picture data on the display area are calculated and a display drawing instruction is generated (step S45). Following this, a check is performed to determine whether an unprocessed picture is present in the pertinent small area (step S46). When the decision is No (present), the process beginning at step S44 is repeated, and unprocessed picture data is handled.

When the process at step S43 is terminated and when the decision at S46 is YES (absent), i.e., when it is ascertained that an unprocessed picture is not present, whether an unprocessed small area is present is determined (step S47). When the decision is NO (an unprocessed small area is present), the processing beginning at step S41 is repeated for the unprocessed small area. When the decision is YES (no unprocessed small area is present), it is assumed that targets to be processed are no longer present, and the processing is terminated.

FIGS. 6A to 6E are diagrams for explaining the overall processing, while the processing performed using the fast, large scale picture data drawing method of this invention and the display results which are thus obtained are shown.

For the original picture data in FIG. 6A, the determination and the other processes included in the flowchart in FIG. 2 are performed for small areas A-1, A-2, A-3, . . . , B-1, B-2, B-3, . . . , C-1, C-2, C-3, . . . , and the picture map data in FIG. 6B are prepared. These picture map data include, at the least, the number of pictures and the original picture pointer for each small area.

Based on the thus obtained picture map data, as is shown in the center portion in FIG. 6, a check is performed to determine whether the display enlargement rate for a targeted small area is low, mid-level or high. When the display enlargement rate is low, it means that a small area is equal to or smaller than one dot, for example, and in this case the processing is performed as is shown in the flowchart in FIG. 3.

As the results which are obtained through the processing, the filling process is performed for areas A-1, A-2 and B-2, including one or more sets of picture data, and the default drawing is obtained as is shown in FIG. 6C. In this case, the areas A-1 and A-2 are contiguous and the filling process is performed at one step to increase the processing speed. The filling process is not performed for an area which includes no picture data.

When at the decision step in the center in FIG. 6 the display enlargement rate is mid-level, e.g., when the small area is about two to five dots, the processing included in the flowchart in FIG. 5 is performed. As the results obtained through the processing, the filling process is performed for the areas A-1 and B-2, including the picture data, and a default drawing is obtained as is shown in FIGS. 6D-1 and 6D-2, while original picture drawing using the picture data is performed for the area A-2. In FIG. 6D-1, the area A-2, consisting of two dots, is displayed by employing default drawing wherein part of the picture data is omitted, and the area in FIG. 6D-2, which has three dots, is displayed by being drawn in a manner similar to that for the original picture data, while omitting part of the data.

When for the decision in the center in FIG. 6 the display enlargement rate is high, e.g., when the small area is equal to or greater than six dots, the processing included in the flowchart in FIG. 4 is performed and all the original picture data are drawn, as is shown in FIG. 6E. In this case, since a default drawing is not required, the drawing data processing time is not reduced for this drawing range. However, since the display enlargement rate is high, the amount of picture data displayed on the screen is reduced because it is regarded as the limited portion of the total data, and the drawing time is adversely affected.

As is described above in detail, according to the fast, large scale picture data drawing method of the invention and the apparatus therefor, in order to draw a large amount of picture data which exceeds the resolution of a display device, a picture position analysis process, wherein the original picture data is not directly drawn, is performed, and picture map data which represents, at the least, the original picture pointer and the number of pictures (density) is prepared for each small area. To actually draw the data on the display screen, the default drawing (filling), the partial default drawing or the original picture drawing is selected while taking the display enlargement rate into account.

According to the method and the apparatus of the invention, while taking into account the resolution of a display device and a display enlargement rate, the picture data process and the drawing process are omitted for a drawing range which is not practically affected, so that an enormous amount of picture data, such as complicated circuit design data and large picture data or various other CAD data, which are represented using XY coordinates, can be drawn on a display screen. As the amount of original picture data is increased and as the display enlargement rate is reduced, the drawing process omissions are increased, as are the processing speed and the drawing speed. When, for example, 100,000,000 sets of picture data are to be drawn on a display device of 1000×1000 dots, conventionally the drawing process must be performed 100,000,000 times, whereas according to the method of the invention, the drawing process for 1000×1000 dots need only be performed 1,000,000 times, thus ensuring that the processing time can be considerably reduced.

As is described above, for a portion which can be identified by a drawing on a display screen, according to the present invention the data are displayed as accurately as possible, and for a portion which, depending on the display resolution or the display enlargement rate, can not readily be identified the data processing and the drawing process are omitted to the extent possible. As a result, the overall processing time can be considerably reduced.

The most preferred embodiment of the present invention has been explained in detail; however, different embodiments can be provided without departing from the spirit and the scope of the present invention. Therefore, while the present invention is limited by the claims, it is not limited to a specific embodiment, and can be variously modified.

What is claimed is:

1. A fast, large scale picture data drawing method comprising the steps of:
regarding original picture data which is to be drawn as picture map data for each of multiple small areas having a predetermined size;
determining, while taking into account the resolution of the display device used for displaying said picture data for each small area, whether the drawing of an original picture should be performed or whether the drawing of a default picture, at least part of which is omitted, should be performed; and
displaying said picture data for each small area, in accordance with the results of the determination, so that the required processing time can be reduced.

2. A fast, large scale picture data drawing method according to claim 1, wherein the size of said small areas is selected in accordance with a display enlargement rate.

3. A fast, large scale picture data drawing method according to claim 1 or 2, wherein said drawing of said default picture is a process performed by filling said small areas.

4. A fast, large scale picture data drawing apparatus comprising:
picture position analysis means for employing data for an original picture to be drawn to prepare picture map data for each small area which is limited to a predetermined size;
drawing method determination means for employing said picture map data prepared by said picture position analysis means to determine whether an original picture or whether a default picture, at least part of which is omitted, should be displayed for said small area;
picture drawing signal generation means for presenting a corresponding display in accordance with the results of the determination obtained by said drawing method determination means; and
display means for displaying the resultant picture data in accordance with the output of said picture drawing signal generation means.

5. A fast, large scale picture data drawing apparatus according to claim 4, wherein said picture position analysis means performs an analysis for each small area in accordance with the resolution of said display means and the display enlargement rate.

6. A fast, large scale picture data drawing apparatus according to claim 4 or 5, wherein said drawing method determination means, in consonance with said resolution of said display means, determines whether the original picture or whether, at the least, said default picture, obtained by the filling process, should be displayed.

7. A fast, large scale picture data drawing method or apparatus according to one of claims 1 to 6, wherein each of said small areas represents a segment obtained by dividing the entire area wherein said picture data are present into a set of segments having a predetermined size.
